(19) United States
(12) Patent Application Publication
(10) Pub. No.: US 2014/0206907 A1
(43) Pub. Date: Jul. 24, 2014

(54) METHOD FOR PREVENTING PRESSURE BUILD UP IN A CATALYST SEPARATION SYSTEM

(71) Applicants: Jason C. Gause, Baytown, TX (US); Gregg M. Sisler, Newark, DE (US); Qun Sun, Wilmington, DE (US)

(72) Inventors: Jason C. Gause, Baytown, TX (US); Gregg M. Sisler, Newark, DE (US); Qun Sun, Wilmington, DE (US)

(73) Assignee: INVISTA North America S.a r.I., Wilmington, DE (US)

(21) Appl. No.: 14/128,309

(22) PCT Filed: Jun. 22, 2012
(86) PCT No.: PCT/US12/43737

§ 371 Date: Mar. 27, 2014

Related U.S. Application Data
(60) Provisional application No. 61/503,689, filed on Jul. 1, 2011.

(51) Int. Cl. C08G 65/26

(52) U.S. Cl. CPC C08G 65/2696
USPC 568/623

(57) ABSTRACT

A method for preventing pressure build-up across a catalyst separation in a polyether polyol reactor comprising the steps of feeding reactants that comprise a monomer or co-monomers to be polymerized to form the polyether polyol into a continuous feed reactor, flowing the product stream through a catalyst separation system within the reactor, wherein the catalyst separation system is comprised of a plurality of filters, wherein each filter comprises an outer surface and an inner surface defined by a plurality of spaced-apart elements, and wherein the distance between the spaced-apart elements is smaller than the minor dimension of the suspended catalyst and recovering the filtered polyether polyol product and catalyst fines from the reactor outlet.

### CROSS-REFERENCE TO RELATED APPLICATION

This application claims the benefit of U.S. Provisional Application No. 61/503,689, filed Jul. 1, 2011, which is incorporated by reference in its entirety.

### FIELD OF THE INVENTION

This disclosure relates to a process for producing polyether glycols. More particularly, the disclosure relates to an improved process for preventing pressure build up across a catalyst separation system in a polyether polyol reactor.

### BACKGROUND OF THE INVENTION

Homopolymers of THF, also known as polytetramethylene ether glycols (PTMEG), are well known for use in spandex, polyurethanes and other elastomers. These homopolymers impart superior mechanical and dynamic properties to polyurethane elastomers, fibers and other forms of final products. Copolymers of THF and at least one other cyclic ether, also known as copolyether glycols, are known for use in similar applications, particularly where the reduced crystallinity imparted by the incorporation of the second cyclic ether may improve certain dynamic properties of a polyurethane which contains such a comonomer as a soft segment. Among the other cyclic ethers used for this purpose are ethylene oxide and propylene oxide. Copolyether glycols having a higher molar incorporation of alkylene oxide are desirable for higher polarity and hydrophilicity as well as improved dynamic properties, for example low temperature flexibility. Copolyether glycols having lower crystallinity are also desirable for use in manufacturing polyurethane and other elastomer which contains such a copolymer as a soft segment.

U.S. Pat. No. 4,120,903 discloses a process for making poly tetramethylene ether glycol (PTMEG) that involves first making the tetramethylene oxide polymer terminated by an acetate ester group (PTMEA). The process makes PTMEA by reacting tetrahydrofuran (THF) with acetic anhydride (ACAN) in a slurry reactor in the presence of a superacid catalyst. This reaction is carried out in a continuous stirred tank reactor (CSTR).

Particularly, U.S. Pat. No. 4,120,903 discloses the polymerization of THF using a polymer containing alpha-fluorosulfonic acid groups as a catalyst and water or 1,4-butanediol as a chain terminator. The nature of the catalyst permits its reuse and thereby eliminates disposal problems. In addition, the catalyst's lack of solubility in the reaction mass makes it desirable to separate the catalyst from the product at the end of the polymerization reaction. This very low solubility also minimizes loss of catalyst as the reaction proceeds.

The crude product is then withdrawn from the reactor through filters and the catalyst particles remain in the reactor for continued use. The filters are called “candle filters” because they protrude (like candles) upwardly into the CSTR. PTFE cloth filters were used for the filters because it was believed that the superacid catalyst would corrode a stainless steel filter and cause it to mechanically fail or that the superacid would leach metal from the stainless steel filters, thus contaminating and destroying the catalyst.

Accordingly, the inventors of the present application originally tried filters consisted of sheets of perforated polytetrafluoroethylene (PTFE, for example Teflon® brand PTFE). However, during filtering the slurry liquid in the reactor, the PTFE cloth filters clogged because they collected an excessive amount of catalyst fines. Further complicating the problem, it was discovered that the solid superacid catalyst swelled to different sizes depending upon the molecular weight of the PTMEA product. Thus sizing the PTFE cloth filters to allow catalyst fines to pass and unbroken catalyst particles to remain in the reactor was unsuccessful.

In addition, catalyst filtration was attempted with wire filters with round cross-section. However, the filters were clogged by catalyst fines and are corroded, causing them to mechanically fail.

Another operational design problem is maintaining effective catalyst filtration with little to no pressure differential across the filtration system in the reactor. The reactor is a continuously stirred tank reactor fitted with a rotating agitator to keep the heterogeneous reaction mass fluidized for maximum contact. The heat generated in the exothermic reaction is removed using evaporative cooling of the low volatile reactor contents using a vacuum system. The vacuum condition in the reactor results in significantly reduced driving force necessary to push the product of the reactor out through the candle filters. These unique operation conditions and design requirements cause the exit flow to essentially rely on gravity and the hydrostatic head of the reactor. If the candle filters provide too much resistance, pressure will build in the filters and it will limit the ability for flow and thus the production rate of the reactor will be decreased. One way to minimize this problem is to allow for periodic backflushing of the filters. However, this process is time consuming and costly, and is consequently not a desired remedy.

Therefore, there is a need for a catalyst separation system that can operate under a low pressure differential, does not require frequent backflush and allows catalyst fines to pass to prevent plugging.

### SUMMARY OF THE INVENTION

The present invention relates to a process for producing a polyether polyol product with a catalyst separation system that effectively operates under a low pressure differential, does not require frequent backflush and allows catalyst fines to pass to prevent plugging of the system.

The catalyst separation system is comprised of a plurality of filters. Each filter is comprised of a plurality of spaced-apart elements. The spaced-apart elements are designed to allow the catalyst fines to pass through the filters and prevent a pressure build up across the catalyst separation system. This particular feature of the present invention enables the catalyst separation system to function under a low pressure differential while allowing the reactor to run at a higher production throughput. It also eliminates the need for excessive backflushing of the filters to unclog plugging. An embodiment of the process comprises the steps of:

(a) feeding reactants that comprise (1) a monomer or (2) a monomer and a co-monomer(s) to be polymerized to form the polyether polyol into a continuous feed reactor, said reactor having a catalyst suspended in solution;
(b) reacting the monomer or co-monomers in the presence of the catalyst to form a product stream comprising a polyether polyol product, unreacted reactants, catalyst fines and suspended catalyst;
(c) flowing the product stream from step (b) into a catalyst separation system within the reactor, wherein the catalyst separation system is comprised of a plurality of filters, wherein each filter comprises an outer surface and an inner surface defined by a plurality of spaced-apart elements, wherein the outer surface of the spaced-apart elements faces the suspended catalyst and is wider than the inner surface of the spaced-apart elements, and wherein the distance between the spaced-apart elements is smaller than the minor dimension of the largest 80% by weight of the suspended catalyst; and
(d) recovering the filtered polyether polyol product, unused reactants and catalyst fines from the reactor outlet.

In one embodiment, the distance between the spaced-apart elements is between 10% and 60% of the minor dimension of the largest 80% by weight of the catalyst.

In another embodiment, the spaced-apart elements do not intersect. In a particular embodiment, the spaced apart elements are formed from a single, spiraling element.

In another embodiment, the spaced-apart elements are wires having a wedged cross-section.

In another embodiment, the spaced-apart elements can have a trapezoidal cross-section, a triangular cross-section or a semi-circle cross-section.

In another embodiment, the distance between the spaced-apart elements is selected to allow the catalyst fines to pass. The distance between the spaced-apart elements can be selected to pass the catalyst fines having a minor dimension of less than 0.2 mm.

In another embodiment, the spaced-apart elements comprise metal that corrodes more slowly than carbon steel in the presence of an acidic ion exchange resin under polymerization reaction conditions.

In another embodiment, the filter is a cylindrical filter. The cylindrical filter may have extensive spaced-apart elements linearly extend in a radial direction of the cylindrical filter, and are arranged around a circumferential direction of the cylindrical filter in a uniform interval. It is also contemplated that the spaced-apart elements may linearly extend in an axial direction of the cylindrical filter.

In another embodiment, the catalyst is a heterogeneous superacid catalyst selected from the group consisting of zeolites optionally activated by acid treatment, sheet silicates optionally activated by acid treatment, sulfate-doped zirconium dioxide, supported catalysts comprising at least one catalytically active oxygen-containing molybdenum and/or tungsten compound or a mixture of such compounds applied to an oxidic support, polymeric catalysts which contain sulfonic acid groups, and combinations thereof. In another embodiment, the catalyst is a polymeric catalyst which contains sulfonic acid groups. In another embodiment, the polymeric catalyst comprises a perfluorosulfonic acid resin. In another embodiment, the superacid catalyst swells in the presence of at least one of the reactants.

In yet another embodiment, the monomer to be polymerized is tetrahydrofuran (THF). In another embodiment, the co-monomer to be polymerized is an alkylene oxide selected from a group consisting of ethylene oxide, 1,2-propylene oxide, 1,3-propylene oxide, 1,2-butylene oxide, 2,3-butylene oxide, 1,3-butylene oxide and combinations thereof.

In another embodiment, the polyether polyol product is polytetramethylene ether acetate (PTMEA). In another embodiment, the polyether polyol product is a copolyether glycol comprising a copolymer of THF and an alkylene oxide, wherein the alkylene oxide is selected from a group consisting of ethylene oxide, 1,2-propylene oxide, 1,3-propylene oxide, 1,2-butylene oxide, 2,3-butylene oxide, 1,3-butylene oxide and combinations thereof.

### BRIEF DESCRIPTION OF THE DRAWINGS

FIG. 1 is a process diagram for an embodiment of the present invention.

FIG. 2 is a filter according to an embodiment of the present invention.

FIG. 3 is a cross-sectional view of FIG. 2 in the vertical direction.

FIG. 4 is a representation of a sectional view of the filter of FIG. 2 showing catalysts of varying swelling being filtered.

FIG. 5 is a representation of a sectional view of the filter of FIG. 2 showing catalyst crowding during filtering.

FIG. 6 is a representation of a sectional view of the filter showing the flow of liquid through the filter opening.

### DETAILED DESCRIPTION OF THE INVENTION

The present invention relates to a process for producing a polyether polyol product with a catalyst separation system that effectively operates under a low pressure differential, does not require frequent backflush and allows catalyst fines to pass to prevent plugging of the system.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

The term “polymerization”, as used herein, unless otherwise indicated, includes the term “copolymerization” within its meaning.

The term “PTMEG”, as used herein, unless otherwise indicated, means poly(tetramethylene ether glycol). PTMEG is also known as polyoxybutylene glycol.

The term “copolyether glycol”, as used herein in the singular, unless otherwise indicated, means copolymers of tetrahydrofuran and at least one other alkylene oxide, which are also known as polyoxybutylene polyoxyalkylene glycols. An example of a copolyether glycol is a copolymer of tetrahydrofuran and ethylene oxide. This copolyether glycol is also known as poly(tetramethylene-co-ethyleneether) glycol. The copolymers produced in the present process are random copolymers in nature.

The term “THF”, as used herein, unless otherwise indicated, means tetrahydrofuran and includes within its meaning alkyl substituted tetrahydrofuran capable of copolymerizing with THF, for example 2-methyltetrahydrofuran, 3-methyltetrahydrofuran, and 3-ethyltetrahydrofuran.

The term “alkylene oxide”, as used herein, unless otherwise indicated, means a compound containing two, three or four carbon atoms in its alkylene oxide ring. The alkylene oxide can be un-substituted or substituted with, for example, linear or branched alkyl of 1 to 6 carbon atoms, or aryl which is un-substituted or substituted by alkyl and/or alkoxy of 1 or 2 carbon atoms, or halogen atoms such as chlorine or fluorine. Examples of such compounds include ethylene oxide (EO); 1,2-propylene oxide; 1,3-propylene oxide; 1,2-butylene oxide; 1,3-butylene oxide; 2,3-butylene oxide; styrene oxide; 2,2-bis-chloromethyl-1,3-propylene oxide; epichlorohydrin; perfluoroalkyl oxiranes, for example (1H, 1H-perfluoropentyl) oxirane; and combinations thereof.

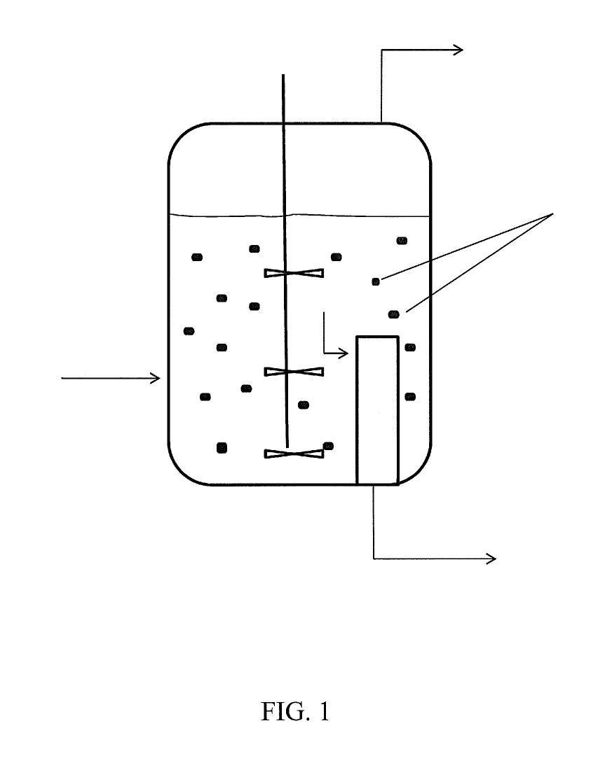

FIG. 1 shows a process diagram of the process for forming a polyether polyol product. An inlet steam 20 feeds reactants that comprise a monomer or co-monomers into the continuous stirred tank reactor (CSTR) 10 to be polymerized. See also U.S. Pat. No. 4,120,903 for a description of the polymerization process. Catalyst particles 103 are suspended within the reactor 10 via mechanical agitation. During polymerization, catalyst fines may be formed due to the attrition of or leaching of the catalyst. After polymerization, a product stream 30 comprising a polyether polyol product, unreacted reactants, catalyst fines and suspended catalyst is formed. The product stream flows into the catalyst separation system 40 that is found in the reactor 10. As will be described in greater detail below, the catalyst separation system 40 retains the suspended catalyst 103 in the reactor 10 and allows an outlet stream 50 comprising polyether polyol product, unreacted reactants and catalyst fines to be recovered from the reactor outlet. By allowing the catalyst fines to pass, pressure build up is prevented across the catalyst separation system 40. This particular feature of the present invention enables the catalyst separation system 40 to function under a low pressure differential while allowing the reactor 10 to run at a higher production throughput. It also eliminates the need to for excessive backflushing of the catalyst separation system 40 to remove plugging.

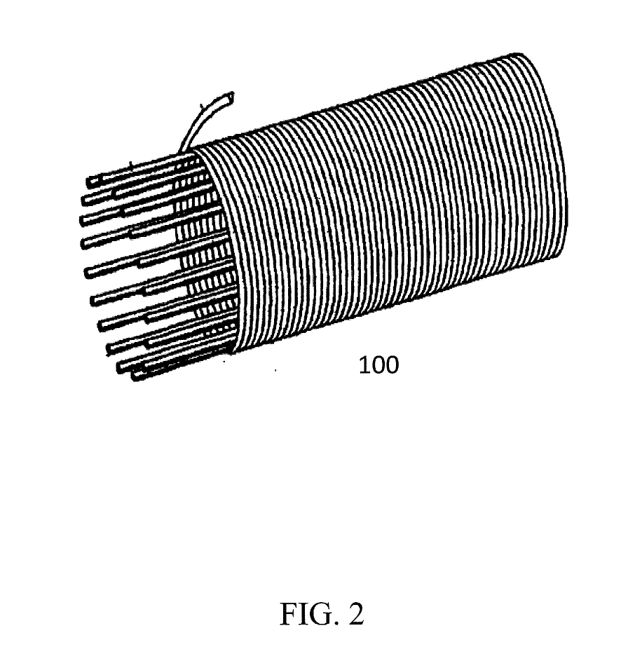

FIGS. 2-6 depict a particular embodiment of present invention wherein the catalyst separation system 40 is comprised of a plurality of filters 100. FIG. 2 shows a representation of a filter 100 according to this exemplary embodiment of the present invention. The plurality of filters 100 may be placed in the reactor 10 in a parallel configuration. In FIG. 2, the filter 100 is a cylindrical filter. However, it is contemplated that the filter may have any geometric shape or be a plane or sheet type of filter in some other embodiments.

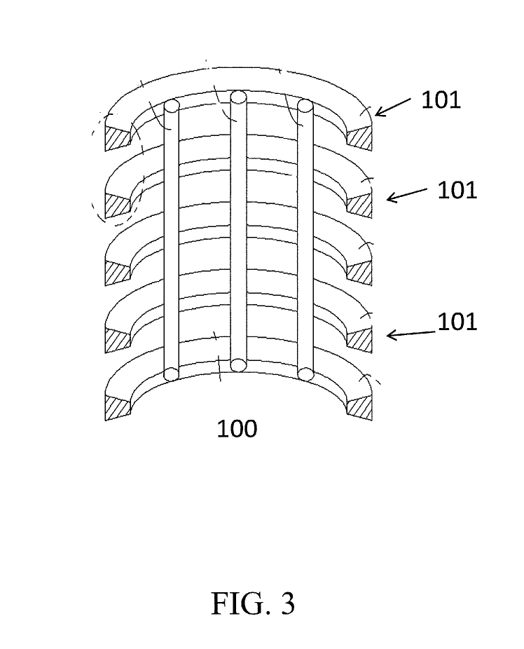

FIG. 3 shows a cross-section view of FIG. 2 in a vertical direction of the cylindrical filter 100. As shown in FIGS. 2-3, the cylindrical filter 100 is comprised of a plurality of spaced-apart elements 101. The spaced-apart elements 101 extend in a radial direction of the cylindrical filter 100, and are arranged around a circumferential direction of the cylindrical filter 100 in a uniform interval. In another embodiment, the spaced-apart elements may also linearly extend in an axial direction of the cylindrical filter.

As shown in FIG. 2 and FIG. 3, the spaced-apart elements 101 are parallel with each other in three-dimensional space and do not intersect. In a particular embodiment, the spaced apart elements are formed from a single, spiraling element.

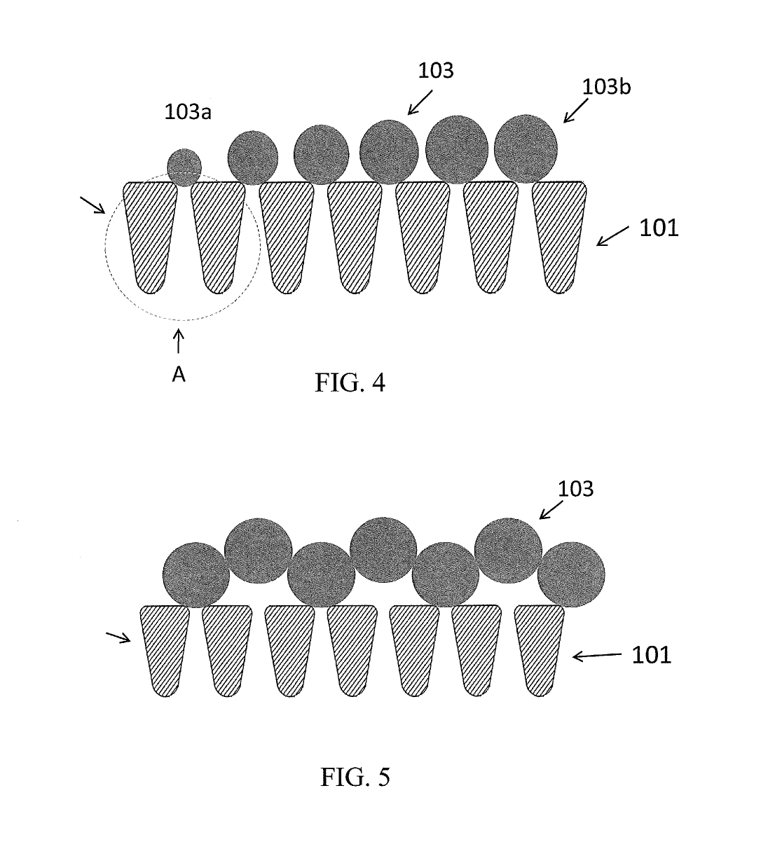

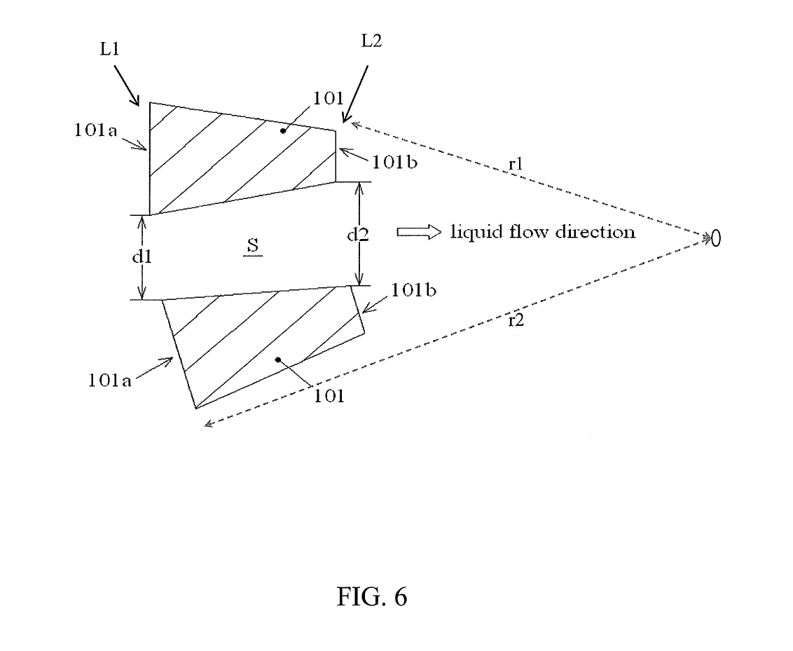

Also as shown in FIG. 2 and FIG. 3, in an exemplary embodiment of the present invention, the spaced-apart elements 101 may be wires having a wedged cross-section. But the present invention is not limited to this cross-sectional shape. In other embodiments of the present invention, the spaced-apart elements 101 may have a trapezoidal cross-section, a triangular cross-section or a semi-circle cross-section. FIGS. 4 and 5 show a cross-section view of the wedge wires of FIG. 2 and FIG. 3. FIG. 6 shows an enlarged view of a portion denoted by “A” of FIG. 4.

Suitable heterogeneous acid catalysts for use herein include, by way of example but not by limitation, zeolites optionally activated by acid treatment, sheet silicates optionally activated by acid treatment, sulfate-doped zirconium dioxide, supported catalysts comprising at least one catalytically active oxygen-containing molybdenum and/or tungsten compound or a mixture of such compounds applied to an oxidic support, polymeric catalysts which contain sulfonic acid groups (optionally with or without carboxylic acid groups), and combinations thereof. The supported catalyst could also include heteropolyacids, heteropolyacid salts, and mixtures of heteropolyacids such that the catalysts are not soluble under the reaction conditions employed here.

Among the suitable polymeric catalysts which contain sulfonic acid groups, optionally with or without carboxylic acid groups, are those whose polymer chains are copolymers of tetrafluoroethylene or chlorotrifluoroethylene and a perfluoroalkyl vinyl ether containing sulfonic acid group precursors (again with or without carboxylic acid groups) as disclosed in U.S. Pat. Nos. 4,163,115 and 5,118,869 and as supplied commercially by E. I. du Pont de Nemours and Company under the tradename Nafion® resin catalyst. Such polymeric catalysts are also referred to as polymers comprising alpha-fluorosulfonic acids. An example of this type of catalyst for use herein is a perfluorosulfonic acid resin, i.e. it comprises a perfluorocarbon backbone and the side chain is represented by the formula —O—CF2CF(CF3)-O—CF2CF2SO3H. Polymers of this type are disclosed in U.S. Pat. No. 3,282,875 and can be made by copolymerization of tetrafluoroethylene (TFE) and the perfluorinated vinyl ether CF2═CF—O—CF2CF(CF3)-O—CF2CF2SO2F, perfluoro (3,6-dioxa-4-methyl-7-octenesulfonyl fluoride) (PDMOF), followed by conversion to sulfonate groups by hydrolysis of the sulfonyl fluoride groups and ion exchanged as necessary to convert them to the desired acidic form. See also U.S. Pat. No. 4,139,567 for a description of perfluorosulfonic acid resin catalyst useful herein.

The polymeric heterogeneous catalysts which can be employed according to the present invention can be used as shaped bodies, for example in the form of beads, cylindrical extrudates, spheres, rings, spirals, or granules. In the exemplary embodiment shown in FIGS. 4 and 5, catalyst particles 103 formed from a cylindrical extrudate are used.

Referring again to FIGS. 4 and 5, the relative size of the cylindrical catalysts 103 to the wedge wires 101 is shown. As will be explained in greater detail with the discussion of FIG. 6, the distance between the wedge wires 101 is selected to prevent the catalysts 103 from passing through. The particular superacid catalyst used may also swell in the presence of at least one of the reactants. When swollen, the catalyst particles 103 maintain their cylindrical shape and may increase in size from two to ten times their original size. Typically, the catalyst particles have been shown to swell from 3 to 5 times their original size. FIG. 4 shows that the filter 100 is designed so that the wedge wires 101 prevent a dry catalyst 103a or a swollen catalyst 103b from passing through. FIG. 5 shows that the design of the wedge wires 101 of the filter 100 also prevent plugging when multiple catalyst particles 103 crowd the openings of the filter. The liquid flow within the reactor 10 also acts to circulate the catalyst particles and further prevents clogging of the filters 100.

The design of the filter 100 for the purpose of preventing pressure build-up across the catalyst separation system 40 will now be discussed in greater detail. As shown in FIG. 6, the outer surface 101a of the wedge wires 101 toward the outer side of the cylindrical filter 100 has a width L1 in the vertical direction. The inner surface 101b of the wedge wires 101 toward the inner side of the cylindrical filter 100 has a width L2 in the vertical direction. The width L1 of the outer surface 101a of the wedge wires 101 is larger than the width L2 of the inner surface 101b of the wedge wires 101.

Referring to FIG. 6, because the width L1 of the outer surface 101a of the wedge wires 101 is larger than the width L2 of the inner surface 101b of the wedge wires 101, the mesh S is formed into a tapered shape. In an embodiment of the current invention, the width L1 may be between 0.5 to 5.0 mm, preferably between 1.0 to 2.0 mm. The width L2 may be between 0.25 to 2.5 mm, preferably between 0.5 to 1.0 mm. In a particular embodiment of the present invention, the width L1 is about 1.194 mm and the width L2 is 0.0597 mm.

Referring to FIG. 6, the distance d1 of the outer opening of the tapered mesh S is less than the distance d2 of the inner opening of the tapered mesh S, and the space d1 between the outer surfaces 101a of adjacent wedge wires 101 is less than the space d2 between the inner surfaces 101b of adjacent wedge wires 101. In this way, the outer opening of the tapered mesh S has the smaller cross-section area, and the inner opening of the tapered mesh S has the largest cross-section area, that is, the cross-section area of the tapered mesh S is gradually enlarged in a direction from the outer surface 101a of the wedge wires 101 to the inner surface 101b of the wedge wires 101.

As shown in an arrow in FIG. 6, when filtering catalyst particles from the product stream, the liquid flows through the tapered mesh S in a direction from the outer opening with the smallest cross-section area to the inner opening with the largest cross-section area of the tapered mesh S. In this way, the small catalyst fines contained in the product stream are unlikely collected in the meshes S, and it can effectively prevent meshes of the filter from being clogged by small catalyst fines accumulated in meshes.

In an exemplary embodiment of the present invention, the tapered meshes may have a degree of taper, K. For a standard mesh filter design with no taper, the widths of 101a and 101b would be defined by d2=d1 and L2=L1.

In case of wedge wire design of a particular embodiment of the present invention, the widths are defined by d2>d1 and L2<L1 and the taper K is defined by d1 divided by d2.

The value of K is defined in the range of 0.1 to 1. Preferably, this range is 0.1 to 0.5 and more preferably equal to 0.3. In FIG. 6, r₁ and r₂ are inner and outer radii from the center point respectively. Note the degree of taper, K, is a function of the minor dimensions of the catalyst particle 103 and the extent of swelling anticipated due to the variations in molecular weight of the reaction product in the reactor 10.

When using the filter 100 shown in FIGS. 1-6 to filter catalyst particles and to prevent the catalyst particles contained in the product stream from passing through the meshes S, the cross-section size d1 of the outer opening of the meshes S of the filter 100 must be less than the minor dimension of the catalyst particles 103, Therefore, the space size d1 between the outer surfaces 101a of adjacent wedge wires 101 must be less than the minor dimension of the catalyst particles. At the same time, in order to allow catalyst fines to smoothly pass through the meshes S, the cross-section size d1 of the outer opening of the meshes S of the filter 100 must be larger than the minor dimension of the catalyst fines. The minor dimension of the catalyst fines is of concern because the catalyst fines that have broken from the catalyst particles may have the same particle length (major dimension) as the original cylindrical catalyst particles. As a result, the space size d1 between the outer surfaces 101a of adjacent wedge wires 101 must be larger than the minor dimension of the catalyst fines. In an exemplary embodiment of the present invention, the minor dimension of the catalyst fines may be within a range of 0.01-0.5 mm. It has been found that to effectively filter the catalyst particles and allow the catalyst fines to pass the cross-section size d1 can be between 0.01 and 0.75 mm, preferably between 0.1 and 0.5 mm. In a particular embodiment of the present invention the minor dimension of the catalyst fines is less than 0.2 mm and the cross section size d1 of the outer opening of the meshes S of the filter 100 is 0.279 mm.

In the exemplary embodiments illustrated in FIGS. 1-6, the wedge wires 101 may be made from a metal, such as stainless steel. Preferably, the wedge wires 101 may comprise metal that corrodes more slowly than carbon steel in the presence of an acidic ion exchange resin under polymerization reaction conditions. However, the present invention is not limited to this embodiment. It is also contemplated that the wedge wires may be made of any other corrosion-resistant material such as polytetrafluoroethylene (PTFE).

### Example 1

Example 1 illustrates the increase of catalyst fines recovered when the catalyst separation system of the current invention is used over a traditional mesh filter. 150 g of wet used Nafion® resin catalyst (about 46.5 g if dried) from the INVISTA LaPorte THF plant was loaded into a flask. The catalyst is in the form of symmetrical cylindrical pellets with an average length and diameter of about 0.8 to 1.0 mm. This used catalyst contains fines that naturally build up in the reaction over several months. The flask was then loaded with THF (2682 g), stirred and drawn out through the filter element at a constant rate and ambient temperature. The flask was reloaded 3 times and each time it was stirred and drawn out through the filter element the same way. In test 1, the filter element was a 4.4 cm² construction consisting of four 250-micron layers over three 500-micron layers of PTFE mesh fabric, the multilayer construction being needed for back-flush strength in a large scale embodiment. The fines that passed through the element were collected in a settler and partly in the final collection flask. The fines were found to have a minor dimension size in the range of about 0.035 to about 0.280 mm, and an average minor dimension size of about 0.150 mm. The results are summarized in Table 1.

TABLE 1

| Flush | Recovered Fines (g) |
|---|---|
| 1 | 0.0052 |
| 2 | 0.0053 |
| 3 | 0.0026 |
| 4 | 0.0079 |
| total | 0.0208 |
| % of recovered fines | 0.046% |

In test 2, the filter element was a 3 cm² rectangular piece of stainless steel type 304 metal wedge wire filter with a 0.279 mm gap (this distance between the spaced-apart elements is within 10%-60% of the minor dimension of the largest 80% by weight of the suspended catalyst, which is between 0.8-1.0 mm), an outer wedge surface width of 1.194 mm and an inner surface wedge width of 0.597 mm, as is used in a particular embodiment of the present invention. The fines that passed through the element were collected in a settler and partly in the final collection flask. The results are summarized in Table 2.

TABLE 2

| Flush | Recovered Fines (g) |
|---|---|
| 1 | 0.0215 |
| 2 | 0.0323 |
| 3 | 0.0223 |
| 4 | 0.0317 |
| total | 0.0993 |
| % of recovered fines | 0.25% |

The fines passed in each test were broken pieces of catalyst fines. No whole catalyst particles passed during the testing. In Test 1, 0.05 wt % of the catalyst loaded passed through the mesh element. In Test 2, 0.25 wt % of the catalyst loaded passed through the wedge wire element. The tests thus showed 5 times as many fines passed using the wedge wire element as using the multilayer mesh element. Thus, the wedge wire filter used with the catalyst separation system of the present invention is more efficient at purging the catalyst fines that can cause back pressure on the filter.

### Example 2

Prevention of pressure build-up across a catalyst separation system in a polyether polyol reactor is accomplished by feeding reactants that comprise a monomer or co-monomers to be polymerized to form the polyether polyol into a continuous feed reactor, said reactor having a catalyst suspended in solution. At least a portion of the monomer or co-monomers are reacted in the presence of the catalyst to form a product stream comprising a polyether polyol product, unreacted reactants, catalyst fines and suspended catalyst.

The product stream then flows into a catalyst separation system within the reactor, wherein the catalyst separation system is comprised of a plurality of filters, wherein each filter comprises an outer surface and an inner surface defined by a plurality of spaced-apart elements, wherein the outer surface of the spaced-apart elements faces the suspended catalyst and is wider than the inner surface of the spaced-apart elements, and wherein the distance between the spaced-apart elements is smaller than the minor dimension of the largest 80% by weight of the suspended catalyst.

The filtered polyether polyol product, unreacted reactants and catalyst fines are then recovered from the reactor outlet.

### Example 3

The process of Example 2 is repeated with additional steps. In this example, the distance between the spaced-apart elements is between 10% and 60% of the minor dimension of the largest 80% by weight of the catalyst.

### Example 4

The process of Example 3 is repeated with additional steps. In this example, the spaced-apart elements do not intersect.

### Example 5

The process of Example 4 is repeated with additional steps. In this example, the spaced apart elements are formed from a single, spiraling element.

### Example 6

The process of Example 5 is repeated with additional steps. In this example, the spaced-apart elements are wires having a wedged cross-section.

### Example 7

The process of Example 6 is repeated with additional steps. In this example, the spaced-apart elements have a trapezoidal cross-section, a triangular cross-section or a semi-circle cross-section.

### Example 8

The process of Example 7 is repeated with additional steps. In this example, the distance between the spaced-apart elements is selected to allow the catalyst fines to pass.

### Example 9

The process of Example 8 is repeated with additional steps. In this example, the distance between the spaced-apart elements is selected to pass the catalyst fines having a minor dimension of less than 0.2 mm.

### Example 10

The process of Example 9 is repeated with additional steps. In this example, the spaced-apart elements comprise metal that corrodes more slowly than carbon steel in the presence of an acidic ion exchange resin under polymerization reaction conditions.

### Example 11

The process of Example 10 is repeated with additional steps. In this example, the filter is a cylindrical filter.

### Example 12

The process of Example 11 is repeated with additional steps. In this example, the spaced-apart elements linearly extend in a radial direction of the cylindrical filter, and are arranged around a circumferential direction of the cylindrical filter in a uniform interval.

### Example 13

The process of Example 12 is repeated with additional steps. In this example, the spaced-apart elements linearly extend in an axial direction of the cylindrical filter, and are arranged around a circumferential direction of the cylindrical filter in a uniform interval.

### Example 14

The process of Example 13 is repeated with additional steps. In this example, the catalyst is a heterogeneous superacid catalyst selected from the group consisting of zeolites optionally activated by acid treatment, sheet silicates optionally activated by acid treatment, sulfate-doped zirconium dioxide, supported catalysts comprising at least one catalytically active oxygen-containing molybdenum and/or tungsten compound or a mixture of such compounds applied to an oxidic support, polymeric catalysts which contain sulfonic acid groups, and combinations thereof.

### Example 15

The process of Example 14 is repeated with additional steps. In this example, the catalyst is a polymeric catalyst which contains sulfonic acid groups.

### Example 16

The process of Example 15 is repeated with additional steps. In this example, the polymeric catalyst comprises a perfluorosulfonic acid resin.

### Example 17

The process of Example 16 is repeated with additional steps. In this example, wherein the superacid catalyst swells in the presence of at least one of the reactants.

### Example 18

The process of Example 17 is repeated with additional steps. In this example, the monomer to be polymerized is tetrahydrofuran (THF).

### Example 19

The process of Example 18 is repeated with additional steps. In this example, the co-monomer to be polymerized is an alkylene oxide selected from a group consisting of ethylene oxide, 1,2-propylene oxide, 1,3-propylene oxide, 1,2-butylene oxide, 2,3-butylene oxide, 1,3-butylene oxide and combinations thereof.

### Example 20

The process of Example 19 is repeated with additional steps. In this example, the polyether polyol product is polytetramethylene ether acetate (PTMEA).

### Example 21

The process of Example 20 is repeated with additional steps. In this example, the polyether polyol product is a copolyether glycol comprising a copolymer of THF and an alkylene oxide, wherein the alkylene oxide is selected from a group consisting of ethylene oxide, 1,2-propylene oxide, 1,3-propylene oxide, 1,2-butylene oxide, 2,3-butylene oxide, 1,3-butylene oxide and combinations thereof.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

What is claimed:

1. A method for preventing pressure build-up across a catalyst separation in a polyether polyol reactor comprising the steps of:
(a) feeding reactants that comprise (1) a monomer or (2) a monomer and a co-monomer(s) to be polymerized to form a polyether polyol into a continuous feed reactor, said reactor having a catalyst suspended in solution;
(b) reacting the monomer or co-monomers in the presence of the catalyst to form a product stream comprising a polyether polyol product, unreacted reactants, catalyst fines and suspended catalyst;
(c) flowing the product stream from step (b) into a catalyst separation system within the reactor, wherein the catalyst separation system is comprised of a plurality of filters, wherein each filter comprises an outer surface and an inner surface defined by a plurality of spaced-apart elements, wherein the outer surface of the spaced-apart elements faces the suspended catalyst and is wider than the inner surface of the spaced-apart elements, and wherein the distance between the spaced-apart elements is smaller than the minor dimension of the largest 80% by weight of the suspended catalyst; and
(d) recovering the filtered polyether polyol product, unreacted reactants and catalyst fines from the reactor outlet.

2. The method of claim 1 wherein the spaced-apart elements do not intersect. And the distance between spaced-apart elements is between 10% and 60% of the minor dimension of the largest 80% by weight of the catalyst.

3. The method of claim 1 wherein the spaced-apart elements have a trapezoidal cross-section, a triangular cross-section or a semi-circle cross-section.

4. The method of claim 1 wherein the spaced apart elements are formed from a single, spiraling element.

5. The method of claim 4 wherein the spaced-apart elements are wires having a wedged cross-section.

6. The method of claim 1 wherein the distance between the spaced-apart elements is selected to allow the catalyst fines to pass.

7. The method of claim 6 wherein the distance between the spaced-apart elements is selected to pass the catalyst fines having a minor dimension of less than 0.2 mm.

8. The method of claim 1 wherein the spaced-apart elements comprise metal that corrodes more slowly than carbon steel in the presence of an acidic ion exchange resin under polymerization reaction conditions.

9. The method of claim 1 wherein the filter is a cylindrical filter, wherein the spaced-apart elements linearly extend in a radial or axial direction of the cylindrical filter, and are arranged around a circumferential direction of the cylindrical filter in a uniform interval.

10. The method of claim 1 wherein the catalyst is a heterogeneous superacid catalyst selected from the group consisting of zeolites optionally activated by acid treatment, sheet silicates optionally activated by acid treatment, sulfate-doped zirconium dioxide, supported catalysts comprising at least one catalytically active oxygen-containing molybdenum and/or tungsten compound or a mixture of such compounds applied to an oxidic support, polymeric catalysts which contain sulfonic acid groups, and combinations thereof.

11. The method of claim 10 wherein the superacid catalyst swells in the presence of at least one of the reactants.

12. The method of claim 10 wherein the catalyst is a polymeric catalyst that comprises sulfonic acid groups, preferably a perfluorosulfonic acid resin.

13. The method of claim 1 wherein the monomer to be polymerized is tetrahydrofuran.

14. The method of claim 1 wherein the co-monomer to be polymerized is an alkylene oxide selected from a group consisting of ethylene oxide, 1,2-propylene oxide, 1,3-propylene oxide, 1,2-butylene oxide, 2,3-butylene oxide, 1,3-butylene oxide and combinations thereof.

15. The method of claim 1 wherein the polyether polyol product is selected from a group consisting of polytetramethylene ether acetate and a copolyether glycol comprising a copolymer of THF and an alkylene oxide, wherein the alkylene oxide is selected from a group consisting of ethylene oxide, 1,2-propylene oxide, 1,3-propylene oxide, 1,2-butylene oxide, 2,3-butylene oxide, 1,3-butylene oxide and combinations thereof.
